(19) United States
(12) Patent Application Publication
(10) Pub. No.: US 2007/0157100 A1
(43) Pub. Date: Jul. 5, 2007

(54) System and method for organization and retrieval of files

(75) Inventor: Kevin Wiggen, San Francisco, CA (US)

Correspondence Address: Trellis Intellectual Property Law Group, PC, 1900 EMBARCADERO ROAD, SUITE 109, PALO ALTO, CA, 94303, US

(73) Assignee: Xythos Software, Inc., San Francisco, CA (US)

(21) Appl. No.: 11/323,934

(22) Filed: Dec. 29, 2005

(51) Int. Cl. G06F 3/048

(52) U.S. Cl. 715/769; 715/837

(57) ABSTRACT

A system and method for selectively handling data. The method includes determining data-handling instructions for a piece of data, such as a file. One or more tasks associated with the file are automatically performed in accordance with the data-handling instructions in response to activation of the data-handling instructions via the file or via a representation thereof. In certain embodiments, the data-handling instructions include workflow instructions. An icon represents a data-handling system interface that is associated with the data-handling instructions. The data-handling system facilitates implementing the data-handling instructions. The icon is selected via the file by placing a graphical representation of the file on the icon representing the data-handling system, thereby activating the data-handling instructions. In an illustrative embodiment, the workflow instructions include delivering the file to a predetermined computer, storing the file in a particular location in a directory structure, retrieving the file or deleting the file at a predetermined time, and so on.

### BACKGROUND OF THE INVENTION

This invention is related in general to information management, and more specifically, to systems and methods for facilitating organization, delivery, and/or retrieval of information, such as information contained in files.

Information-management systems are employed in various demanding applications including databases, file-servers, and digital storage devices. Such applications often demand user friendly file-management systems that provide simple and intuitive interfaces for facilitating retrieving and organizing files and other types of information.

User friendly and efficient file-management systems are particularly important in personal-computer and related network applications, which often rely heavily on file-access and retrieval operations. Certain conventional file-management systems, such as Windows Explorer® or Microsoft Outlook® often provide undesirably complicated or otherwise limited user interfaces. Furthermore, users may readily forget where or how they stored certain files using such systems. Consequently, users must often traverse complicated file-directory structures or activate separate software to perform additional time-consuming searches to retrieve, organize, and/or send desired information. Furthermore, other software applications that rely upon on relatively complicated or awkward underlying file-retrieval systems may be further complicated thereby.

### SUMMARY OF THE INVENTION

Certain embodiments of the present invention provide a method for selectively handling data. The method includes determining data-handling instructions for a file. The method further includes automatically performing one or more tasks associated with the file and in accordance with the data-handling instructions in response to activation of the data-handling instructions via the file or via a representation thereof. Note that “data-handling nstructions” can include any type of data processing instruction, command, operator or other mechanism for controlling, transferring, computing, manipulating, etc., a file or any other data or a portion or piece of a file or data.

In a more specific embodiment, the data-handling instructions are activated in response to placing a graphical representation of the piece of data on an icon associated with a data-handling system. The data-handling system is adapted to facilitate implementing the data-handling instructions in response to placing the graphical representation of the piece of data on the icon.

In an illustrative embodiment, the data-handling instructions include workflow instructions, which include delivering the file to a predetermined computer. Alternatively, the data-handling instructions include storing the file in a particular location in a directory structure, wherein the particular directory structure is based on a file description that is incorporated in or associated with the data-handling instructions. As another example, the data-handling instructions may also include retrieving the file or deleting the file at a predetermined time. Data-handling instructions may also be based on file-type information or information existing within a file, such as meta-data in the file.

Hence, unlike conventional information-handling methods, certain embodiments of the present invention may facilitate automatic filing, retrieving, sending, etc. of information based on predetermined information-handling preferences. The preferences may be automatically determined via an accompanying system, or they may be adjusted by a user. Consequently, certain embodiments of the present invention facilitate otherwise complicated information-handling tasks, such as creating directory structures, filing files in the directory structures, retrieving files, emailing files, periodically deleting files, and so on.

### BRIEF DESCRIPTION OF THE DRAWINGS

FIG. 1 is a diagram illustrating an exemplary information-management interface according to an embodiment of the present invention.

FIG. 2 is a diagram illustrating an exemplary questionnaire activated in response to placing an item on the information-management interface of FIG. 1.

FIG. 3 is a diagram illustrating an exemplary dialog box activated via the questionnaire of FIG. 2.

FIG. 4 is a diagram illustrating an exemplary pop-up menus activated in response to clicking the information management interface of FIG. 1.

FIG. 5 is a diagram illustrating key functional modules of an information-management system employed to implement the information-management interface of FIGS. 1, 2, and 4.

FIG. 6 is a flow diagram of a first exemplary method adapted for use with the information-management interface and accompanying information-management system of FIG. 5.

FIG. 7 is a flow diagram of a second exemplary method adapted for use with the information-management interface and accompanying information-management system of FIG. 5.

### DETAILED DESCRIPTION OF EMBODIMENTS OF THE INVENTION

For clarity, various well-known components, such as hard disks, power supplies, operating systems, communications ports, hubs, modems, gateways, firewalls, network cards, Internet Service Providers (ISPs), computer-mice pointers, cursors, and so on, have been omitted from the figures. However, those skilled in the art with access to the present teachings will know which components to implement and how to implement them to meet the needs of a given application.

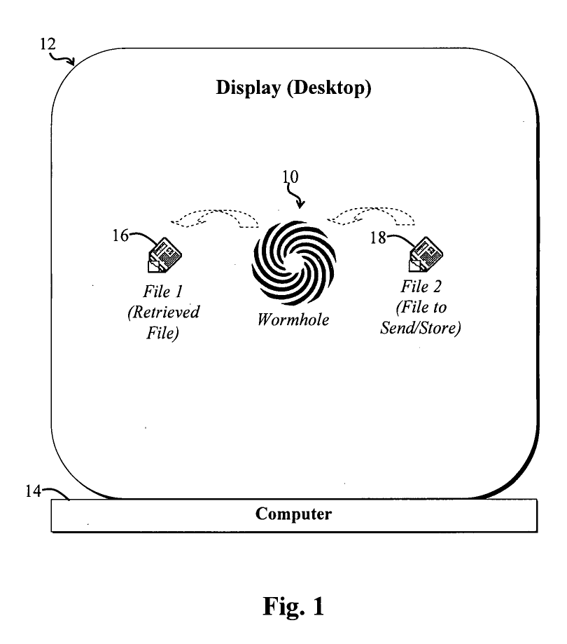

FIG. 1 is a diagram illustrating an exemplary information-management interface 10 according to an embodiment of the present invention. The information-management interface 10 and associated functionality is called a wormhole or wormhole interface for the purposes of the present discussion. The wormhole interface 10 appears on a computer display 12. The display 12 communicates with a computer 14, which runs software and/or hardware for implementing the wormhole interface 10 as discussed more fully below. The wormhole interface 10 may reside in various hardware/software environments, including stand-along computer and network environments. The wormhole interface 10 may appear in various display environments, such as an operating-system desktop environment, such as the Windows XP® desktop.

For illustrative purposes, the display 12 illustrates a first file (file 1) 16, which has been retrieved by a user from the wormhole interface 10 or has otherwise been output or delivered via the wormhole interface 10. The wormhole interface 10 may be configured to automatically retrieve or deliver the first file 16 to the display 12. Note that although features of the invention are discussed primarily with respect to files, that any number, type or arrangement of information or piece of data can similarly be used. For example, a file or unit of information can be a byte, word, array, data structure, email, document, plain-text, encoded information, database record, database, directory structure, metadata, etc. or group or portion thereof.

A second file (file 2) 18 will be placed on the wormhole interface 10 via a user. Exact details pertaining to how a user places a file on the wormhole interface 10 or activates certain functionality of the wormhole interface 10 are application specific. For example, a user may employ functionality of the native operating system to facilitate placing the file 18 on the wormhole interface 10. For example, in a Windows® environment, a user may employ a mouse to click and drag the second file 18 onto the wormhole interface 10. The first file 16 and the second file 18 may represent icons associated with first and second files, respectively, rather than the files themselves, without departing from the scope of the present invention.

In operation, the wormhole interface 10 exhibits various capabilities, including automatic filing, file retrieval, file delivery, and so on. The wormhole interface 10 and accompanying functionality act as a system for selectively managing or handling information, such as files. The management of the information may include selective performance of workflows, which may include, for example, logging onto remote computers, delivering the information to persons of specific groups with an accompanying note, and so on.

The wormhole interface 10 and accompanying functionality may act as a type of information switch, where each file 16, 18 is handled by the wormhole interface 10 based on auxiliary information associated with each file 16, 18. The auxiliary information may be implemented as a file tag or header, which is appended to or otherwise attached to or associated with each file 16, 18. Alternatively, the auxiliary file information may be stored separately from each file 16, 18, such as in a database, wherein each entry in the database references the appropriate file.

For the purposes of the present discussion, a file may be any piece of information stored via an electronically accessible storage medium, including image data, text, executables, meta-data that the storage medium may be storing along with the bytes representing other file data, and so on. The terms auxiliary file information, file-access information, and access-log information are employed interchangeably in the present discussion.

In the present specific embodiment, to send, file, or implement a workflow associated with the second file 18, the second file 18 is merely placed on the wormhole 10. The wormhole interface 10 then activates one or more menus as needed to obtain requisite information from the user to enable the wormhole interface 10 to handle the file 18 as desired by the user.

Alternatively, the wormhole 10 is activated by selecting the file 18 to activate a menu that provides a selectable wormhole filing option as discussed more fully below. For example, software for implementing the wormhole 10 may facilitate creating a wormhole menu option (not shown) that appears when right-clicking the files 16, 18. Selecting the wormhole menu option could be equivalent to placing the file 16 or 18 on the wormhole interface icon 10.

A user may search for a particular file by selecting the wormhole interface 10, such as by clicking on the wormhole interface 10. Various search options may appear that enable a user to quickly retrieve previously filed files. The search options may enable a user to enter general file descriptions or other relevant information that may have been recorded as auxiliary information when the file was initially stored via the wormhole interface 10. The present embodiment employs functionality that facilitates entering various file descriptions, commands, and so on, as auxiliary information to enhance user friendliness while simultaneously expanding user options.

For example, a user may enter a command via one or more wormhole options menus, as discussed more fully below, to cause the wormhole interface 10 to search for all files that were saved when the weather was cloudy. The wormhole interface 10 may then selectively access the auxiliary file information and/or a separate weather database to determine when a particular file was saved, modified, printed, and so on, and if the weather was cloudy when the file was saved, modified, printed, etc. Matching files are then listed or delivered depending on predetermined wormhole options. Such a search represents a type of a workflow that is implementable via the wormhole interface 10. The wormhole interface 10 may implement various types of workflows as discussed more fully below.

Hence, the wormhole interface 10 may act as a single, simple gateway to versatile functionality pertaining to file handling and organization. In certain applications, wormhole interface 10 may be used as merely a mechanism to facilitate storing “reference” material. Users wishing to store files for future reference, such as instructions, notes, and so on, may place the files on the wormhole interface 10 without concern for where the files are stored but with knowledge that a simple search may be employed to retrieve the files when needed. If desired, user may see where files are placed by the wormhole interface 10. For example, a user may employ the wormhole interface 10 to see that and/or to specify that files placed on the wormhole interface 10 be placed on a local machine and/or on a central server.

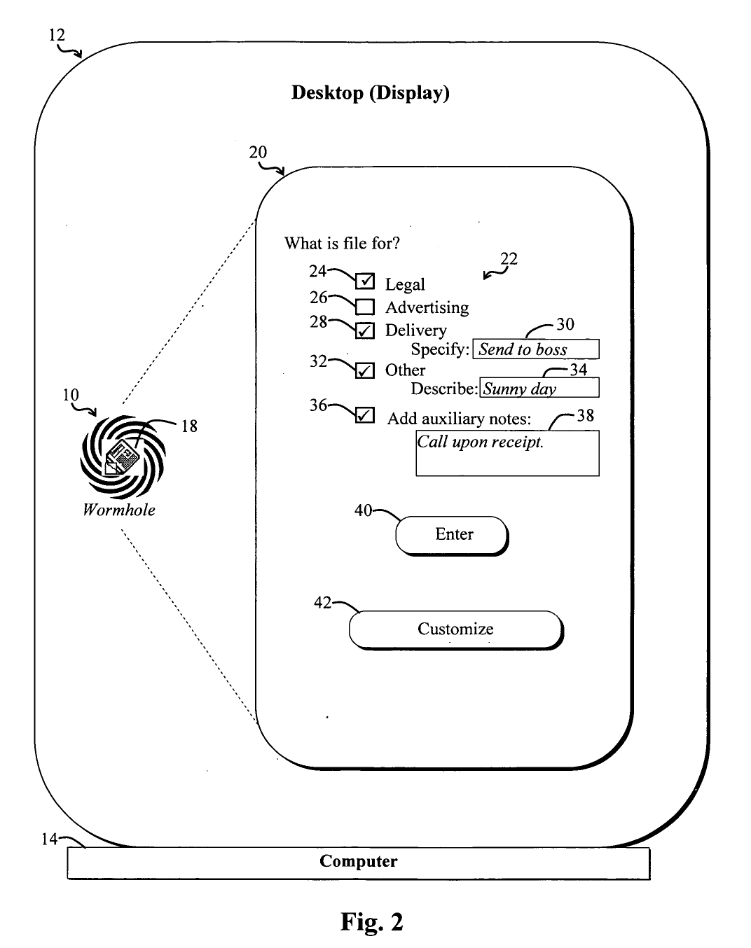

FIG. 2 is a diagram illustrating an exemplary questionnaire 20 activated in response to placing an item, such as the second file 18, on the wormhole information-management interface 10 of FIG. 1. In the present specific embodiment, the questionnaire 20 asks the user what the file 18 is for and provides various options and fields 22 to enable the user specify how the file 18 should be handled by the wormhole interface 10. The options and fields 22 include a legal checkbox 24, an advertising checkbox 26, a delivery checkbox 28 and an accompanying specification field 30, an other checkbox 32 and an accompanying description field 34, an enter button 40, a customization button 42, and a notes checkbox 36 and an accompanying notes field 38.

A default reference checkbox 23 is automatically selected by the wormhole interface 10, indicating that, unless otherwise specified, files will be stored for future retrieval, i.e., future reference. The default checkbox 23 is chosen with knowledge that typically users employing the present embodiment will wish that information be stored for future reference. Consequently, users often can press the enter button 40 without entering or selecting additional options. Default selections and checkboxes may be customized without departing from the scope of the present invention.

In operation, a user has configured or customized the questionnaire 20 to include the options and fields 22. The user may employ the customize button 42 to invoke additional customization screens (not shown) to add or remove various options and fields 22.

In the present specific embodiment, the second file 18 represents a legal document. Accordingly, a user has selected the legal checkbox 24 in questionnaire 20 that was activated in response to placing the second file 18 on the wormhole interface icon 10. In addition, the user has selected the delivery checkbox 28 and has specified that the file 18 be sent by the wormhole interface 10 to the user's boss. Note that the wormhole interface 10 may have already logged the email address or other delivery address pertaining to the user's boss. If the wormhole interface 10 does not have the email address for the user's boss or other information required to deliver the file 18, then an appropriate screen (not shown) asking for the boss's delivery information will be activated in response to selecting the enter button 40. After the user enters the boss's delivery information, the wormhole interface 10 then remembers the boss's delivery information (email) so that the user will not need to re-enter the information for subsequent files to be sent to the boss.

For illustrative purposes, the user has selected the other checkbox 32 and added an additional description 34 associating the file with a sunny day. The user has not checked the advertising checkbox 26. Accordingly, the file 18 will not be treated by the wormhole interface 10 as an advertising file. The user has also selected to append an auxiliary note 38 to the file 18 requesting that the boss call the user upon receipt of the file. The wormhole interface 10 may implement one or more routines to associate the notes in the auxiliary note field 38 with the file 18 so that a user may read the associated note by performing a mouse-over of the file icon 18. Note that a mouse-over occurs when the user positions a mouse cursor (not shown) over the file 18. Other methods for enabling a user to read the note field 38 may be employed without departing from the scope of the present invention.

Various screens, such as customization screens and screens enabling a user to enter file delivery addresses, which are not shown in the present embodiment, are application specific. Such screens may be determined and implemented by those skilled in the art with access to the present teachings to meet the needs of a given application without undue experimentation.

In the present operative scenario, the user selects the enter button 40 after completing the questionnaire 20. Depending on how the wormhole interface 10 is configured, an additional screen may appear asking the user for additional information as discussed more fully below. After completion of the questionnaire 20 and any related questionnaires and/or configuration screens, the wormhole interface 10 and accompanying functionality then perform appropriate tasks pertaining to the file 18 based on the information obtained via the questionnaire 20 and based on information obtained via related screens and/or further based on information already stored or otherwise accessible by the wormhole interface 10. In the present operative scenario, the file 18 is saved in an automatically generated directory as discussed more fully below. For example, the file 18 may be filed in a legal directory in an automatically generated directory structure. Alternatively, the file 18 is merely tagged and placed in a directory along with other wormhole files, which may be selectively retrieved based on the tag information.

For the purposes of the present discussion, a file is tagged when auxiliary information is associated with the file. The auxiliary information may be stored in a separate database that includes a pointer to the file or the auxiliary information may be attached to or otherwise be appended to the file. The auxiliary information may include any information to be associated with a file, such as the second file 18.

In addition to storing the file 18 in an appropriate directory, the wormhole interface 10 delivers the file 18 to an appropriate email address or other delivery address associated with the user's boss as specified via the delivery checkbox 28 and accompanying description field 30. Alternatively, the file 18 is tagged with auxiliary information pertaining to results of the questionnaire 20 and is delivered to the boss without also storing the file in an appropriate directory on the user's computer 14 or other computer or memory accessible by the computer 14. Such options further detailing how files are handled may be specified via options available in additional application-specific screens.

An example of another option item that may be implemented via the questionnaire 20 is a to-do list (not shown). For example, in the present scenario, the boss would receive the file 18 with an accompanying notice indicating that the user has additional tasks to complete. The additional to-do list may be automatically generated by the wormhole interface 10 without departing from the scope of the present invention. The notice may be implemented via a text bubble or other mechanism that may be activated in various ways, such as by mousing-over a file that was sent via the wormhole interface 10.

To retrieve the file 18 from storage in an automatically generated directory, a user may select the wormhole interface 10, such as by clicking on the wormhole interface icon 10. An additional screen may appear that enables a user to enter one or more search criteria as discussed more fully below. The search criteria are then employed by the wormhole interface 10 to search auxiliary file information and/or automatically generated directories for files that are associated with the search criteria.

In an alternative implementation, appropriate questionnaires are automatically completed by software incorporated within the wormhole interface 10 or otherwise called by or associated with the wormhole interface 10. Various algorithms for analyzing and indexing files may be employed to automatically complete appropriate questionnaires. For example, search-engine indexing software, such as indexing software made by Google®, could be employed analyze each file as it is dropped on the wormhole interface 10. The results of the analysis, which may include title, author, key words, and so on would then be tagged to the file 18 or otherwise associated with the file 18 to facilitate subsequent retrieval of the file 18 via the wormhole interface 10 in response to a file search triggered by selecting the wormhole interface 10. Note that certain embodiments of the present invention do not use automatically generated directory structures for filing.

Once the search has been entered, a list of search results indicating possible matches, also called hits, is returned to the user as discussed more fully below. Once the user selects the file he/she wants from the list of search results, the file is then returned to the user or to an application that the user is using to access wormhole functionality. In this embodiment, the file may be returned to the user's desktop 12. Note that the user may be an application, such as a hardware or software application.

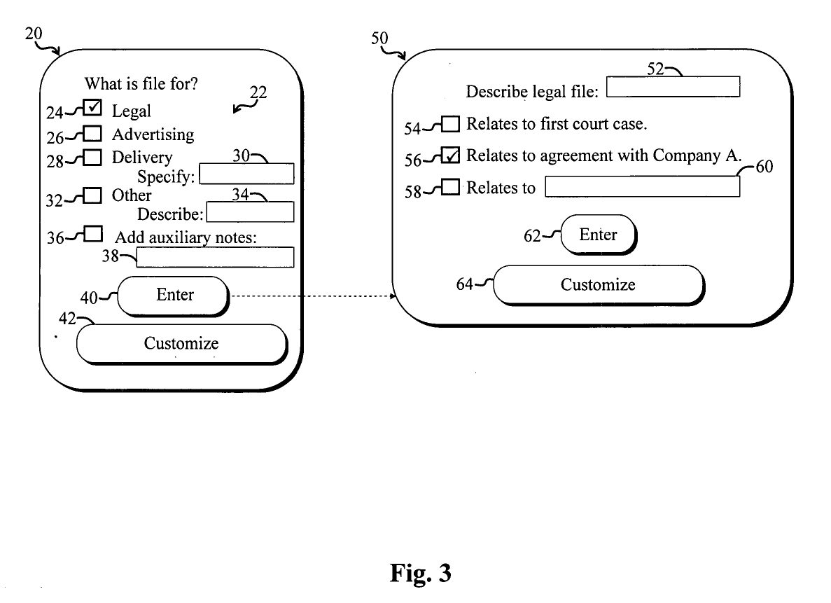

FIG. 3 is a diagram illustrating an exemplary dialog box 50 activated via the questionnaire 20 of FIG. 2. In the dialog box 20 as illustrated in FIG. 3, a user has selected the legal checkbox option 24. For clarity, the remaining options and fields 26-38 were left blank. A user activates the exemplary legal-detail dialog box 50 in response to selecting the enter button 40 from the first questionnaire 20 after having selected the legal checkbox 24. For the purposes of the present discussion, the terms questionnaire, dialog box, and menu are employed interchangeably.

For illustrative purposes, the legal-detail dialog box 50 includes a description field 52, a customized court-case checkbox 54, a company-A checkbox 56, and a relation checkbox 58 with an accompanying note field 60. The legal-detail dialog box 50 is a customized dialog box, which is customizable via one or more dialog boxes (not shown) that are activated in response to pressing the customize button 64. Note that these extra questions implemented by the legal-detail dialog box 50 could be set up by the user or by a system administrator. Both personal and system-wide questions may appear to the user.

In operation, with reference to FIGS. 2 and 3, the user has chosen to categorize, tag, or otherwise associate the second file 18 placed on the wormhole interface 10 with legal documents pertaining to Company A by selecting the legal checkbox 24 of the questionnaire 20 and by further selecting the Company-A checkbox 56 in the legal-detail dialog box 50.

The user has additional options provided by the legal-detail dialog box 50, including further describing the file via the description field 52, adding more detail pertaining to how the document relates to Company A by selecting the relation checkbox 58 and entering pertinent notes in the adjacent note field 60, and so on. Upon activating an additional enter button 62 appearing in the legal-detail dialog box 50, the dialog boxes 20, 50 may disappear, leaving the wormhole interface 10 of FIGS. 1-2 remaining.

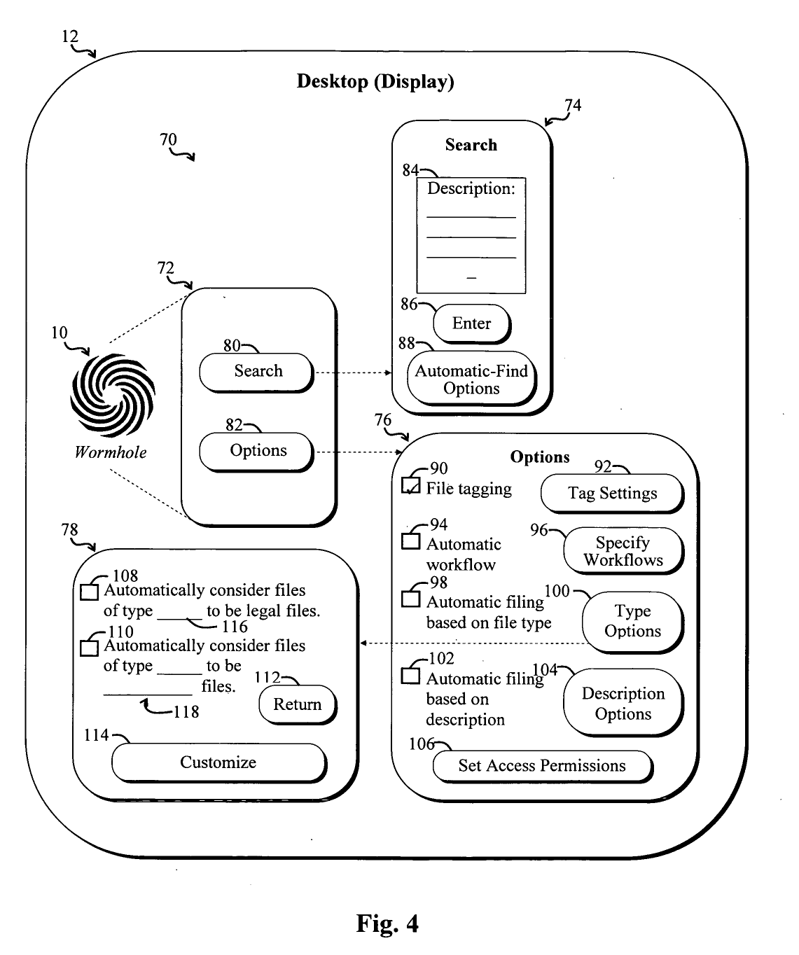

FIG. 4 is a diagram illustrating an exemplary pop-up menus 70 activated in response to clicking or otherwise selecting the wormhole-information management interface 10 of FIGS. 1 and 2. In the present specific embodiment, the menus 70 include an initial search/option-button dialog box 72 from which may be activated a search dialog box 74 and/or an options dialog box 76. For illustrative purposes, a type-options dialog box 78 is shown activated via the options dialog box 76. Those skilled in the art will appreciate that the activated menus, options contained therein, and ways of accessing the menus are application specific and may be readily modified to meet the needs of a given application without undue experimentation.

The exemplary search/option-button dialog box 72 includes an initial search button 80 and an initial options button 82. The search dialog box 74 is displayed in response to selection of the search button 80. The search dialog box 74 includes a search-description field 84 a search-enter button 86, and an automatic-find options button 88.

In operation, a user employs the description field 84 to enter a description of one or more files to be found by the wormhole interface 10. The description might include a file name or other data that might occur in the auxiliary information associated with the file. The auxiliary information may have been initially associated with the file via one or more questionnaires, such as the questionnaire 20 of FIG. 2, which were activated when initially filing the file. Upon selecting the search-enter button 86, the wormhole interface 10 and accompanying functionality search one or more automatically generated directories for files matching the description entered in the description field 84. The description field 84 might specify for example: Sent to boss; sunny day. The wormhole interface 10 would then retrieve the second file 18 that was filed in the illustrative scenario depicted in FIG. 2.

In the present specific embodiment, additional automatic-find options 88 may be specified by completing one or more additional menus (not shown) in response to selecting the automatic-find options button 88. The automatic-find options button 88 may be employed to customize the search dialog box 74. For example, one or more checkboxes may be added to the search dialog box 74.

After retrieving the search results upon selection of the search-enter button 86, one or more screens (not shown) listing files that were retrieved by the wormhole interface 10 may be listed. The files may be listed according to priority order in accordance with the teachings of co-pending U.S. patent application Ser. No. 11/251,550, entitled SYSTEM AND METHOD FOR PERFORMING FILE SEARCHES AND RANKING RESULTS, and assigned to the assignee of the present invention, the teachings of which are incorporated by reference herein. Furthermore, the search dialog box 74 may be implemented according to the teachings of the above-identified U.S. patent application.

When a user selects the options button 82 from the search/option-button dialog box 72, the options dialog box 76 appears. For illustrative purposes, the options dialog box 76 is shown including a file-tagging checkbox 90 and accompanying tag-settings button 92, an automatic-workflow checkbox 94 and an accompanying specify-workflow button 96, an automatic type-filing checkbox 98 and accompanying type-options button 100, an automatic description-filing checkbox 102 and accompanying description-options button 104, and an access-permissions button 106.

In operation, in the present illustrative scenario, the user has selected the file-tagging checkbox 90. Consequently, when files, such as the second file 18 of FIGS. 1 and 2, are placed on the wormhole interface for filing, sending, or implementing other workflows, the files are tagged with auxiliary information. Further application-specific details of how files are tagged may be established by selecting the tag-settings button 92.

If a user has selected the automatic workflow checkbox 94, the wormhole 10 would implement workflows in accordance with user options specified via the specify-workflow button 96. For example, upon selecting the specify-workflows button 96, the user may specify login usernames, passwords, emails, and so on to facilitate implementing workflows.

If the user has selected the automatic type-filing checkbox 98, then the wormhole interface 10 will automatically file files, such as the second file 18 of FIGS. 1 and 2, placed on the wormhole interface 10 according to file type in accordance with type-filing options/instructions established via selecting the type-options button 100. Note that in certain configurations or implementations files may be automatically filed in accordance with file type information and in accordance with other auxiliary information associated with the file depending on the selected type-filing options. If the user has selected to automatically file files based on file-type information alone, then the questionnaire 20 of FIGS. 2 and 3 may be bypassed.

If the user has selected the automatic description-filing checkbox 102, the wormhole interface 10 would automatically file the file 18 of FIGS. 1 and 2 according to the description options specified in via the description-options button 104. In certain implementations, file descriptions may be automatically generated or specified by the user in advance of placing the file 18 on the wormhole interface 10. In such implementations, the questionnaire 20 of FIGS. 2 and 3 may be bypassed.

A user may employ the access-permissions button 106 to set access permissions for files exhibiting predetermined descriptions, file types, workflows, and so on. For example, the permissions may specify who can see, open, or otherwise access a particular file, and at what times. For example, persons belong to particular groups may be granted file-access permission on a specific day of the week, while persons belonging to other groups may be restricted from accessing a given file at any time.

Details of various dialog boxes and menus activated in response to selecting the buttons 92, 96, 100, 104, and 106 of the options dialog box 76 are application specific. Such dialog boxes and menus may be readily determined by those skilled in the art to meet the needs of a given application without undue experimentation.

For illustrative purposes, the type-options dialog box 78 is shown activated in response to selection of the type-options button 100. The exemplary type-options dialog box 78 includes a legal-association checkbox 108, a wildcard-association checkbox 110, a return button 112, and an additional customize button 114.

In operation, a user may select the legal-association checkbox 108 and simultaneously specify which type of files should be automatically associated with legal files by entering the file type(s) in an accompanying file-type filed 116. Similarly, a user may select the wildcard-association checkbox 110 and simultaneously associate certain file types with a description or otherwise specify how certain file types are to be categorized by entering appropriate information in accompanying description fields 118.

A user may further customize the dialog box 78 in response to selecting the customize button 114. After the user is finished entering data and options in the type-options dialog box 78, the return button 112 is selected, which returns the user to the options dialog box 76.

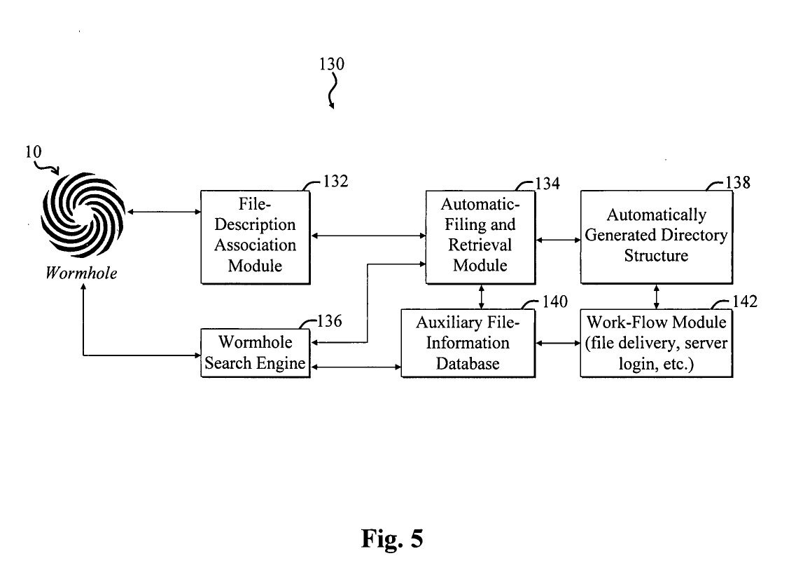

FIG. 5 is a diagram illustrating key functional modules of a wormhole information-management system 130 employed to implement the wormhole information-management interface 10 of FIGS. 1, 2, and 4. In the present specific embodiment, the system 130 includes a file-description association module 132, which communicates with the wormhole interface icon 10 and an automatic-filing and retrieval module 134. The automatic-filing and retrieval module 134 further communicates with a wormhole search engine 136, an automatically generated directory structure 138, and an auxiliary file-information database 140. The wormhole search engine 136 communicates with the wormhole interface icon 10, the automatic-filing and retrieval module 134, and the auxiliary file-information database 140. The auxiliary file-information database 140 further communicates with a workflow module 142 in addition to the wormhole search engine 136 and the automatic-filing and retrieval module 134. The workflow module 142 further communicates with the automatically generated directory structure 138.

In operation, with reference to FIGS. 1-5, the wormhole search engine 136 maintains routines, such as software and/or hardware routines, for implementing searches triggered via the search dialog box 74 of FIG. 4. Similarly, the file-description association module 132 maintains routines for associating files with auxiliary information, such as in response to completion of the dialog boxes 10, 50 of FIG. 3 and options dialog boxes 76, 78 activated via the options button 82 of FIG. 4. Software for implementing the menus 20, 50, 72-78 is graphically represented by the wormhole interface icon 10 itself.

The file-description association module 132 associates files placed on the wormhole 10 with auxiliary information, which together with the file 18 (See FIG. 2.), is forwarded to the automatic-filing and retrieval module 134. In the present specific embodiment, the automatic-filing and retrieval module 134 stores the auxiliary information in the auxiliary file-information database 140 and indexes the information so that the auxiliary information is associated with the appropriate file 18. In an alternative implementation, the auxiliary information is appended to the file, thereby obviating the auxiliary file-information database in certain applications. This file may live locally on the machine, on a central machine, or both.

The description of the file 18 as represented via the auxiliary file information is employed by the automatic-filing and retrieval module 134 to automatically generate one or more directories 13 as needed to store the file in accordance with the auxiliary file information. For example, if the file 18 is a legal file associated with Company A, the automatic-filing and retrieval module 134 will generate a legal directory if a legal directory is not already created. The automatic-filing and retrieval module 134 will then generate a subdirectory for Company A if one is not already present in the automatically generated directory structure 138.

In an alternative implementation, the automatically generated directory structure 138 is a single directory that maintains each file along with an appropriate index to auxiliary information in the auxiliary file-information database 140. Alternatively, the auxiliary information is appended to the file, thereby obviating the index.

To search for a file, the search engine 136 searches the auxiliary information in the auxiliary file-information database 140 to find auxiliary information that matches specified search criteria or a specific description. The associated file is then retrieved from the automatically generated directory structure 138 by the automatic-filing and retrieval module 1345 in response to a request by the wormhole search engine 136. The request sent by the wormhole search engine 136 to the automatic-filing and retrieval module 134 may include the index(es) associated with the one or more matching files, which are associated with corresponding matching auxiliary information. The wormhole search engine 136 may incorporate additional functionality to search the contents of files themselves, not just auxiliary information, in the automatically generated directory structure 138.

In the alternative implementation wherein auxiliary file information is attached to or otherwise accompanies each file in the automatically generated directory structure 138, the wormhole search engine 136 may directly search the directory structure 138 for files and/or auxiliary information matching predetermined search criteria.

To implement a workflow for a particular file, details specifying the workflow are maintained in the auxiliary file information provided by the file-description association module 132 to the automatic-filing and retrieval module 134. This auxiliary information may include workflow options and file-access permission information, which may be stored in the auxiliary file-information database 140. The workflow module 142 selectively accesses the auxiliary information. The workflow module 142 then accesses the file from the automatically generated directory structure 138 based on the auxiliary file information and further facilitates handling the file according to file-handling, i.e., workflow instructions contained in the associated auxiliary information maintained in the auxiliary file-information database 140.

The workflow module 142 may interact with other workflow modules associated with different wormhole interfaces running on different computers (not shown) to facilitate delivering files to the wormhole interface 10 from other wormhole interfaces as needed. Note other types of files may appear from the wormhole interface 10. For example, the wormhole interface 10 may be configured so that the accompanying wormhole system 130 implements searches for specific files at specific times. The search results are then periodically delivered to the user via the wormhole interface 10. The results may automatically appear on a user's desktop. Alternatively, the results appear in an organized list that may be activated in response to selection of the wormhole interface 10.

Hence, the wormhole interface 10 may act as a type of intelligent information gateway, wherein incoming files may be automatically tagged or otherwise associated with auxiliary information as desired. The file-description association module 132 may facilitate obtaining the auxiliary information by generating predetermined questions and providing predetermined options, such as illustrated in the questionnaire 20 of FIG. 2.

The workflow module 142 may be configured, such as via the specify-workflows button 96 of the options dialog box 76 of FIG. 4 to automatically find files matching specific criteria and then automatically deliver them to the desktop 12 of FIG. 1 at predetermined time intervals. Furthermore, the workflow module 142 may be configured to automatically delete files or otherwise place the files a specific folder, such as a deleted-items folder, at certain times based on predefined user-specified rules.

As another example, a workflow might specify that the workflow module 142 automatically log in or log out of specific networked machines, websites, secure server, and/or other computers, and then download or upload information as desired. Requisite login and password information may be maintained as auxiliary file information in the auxiliary file-information database 140 or otherwise may be stored as wormhole configuration settings that are tagged to the file. Hence, the workflow module 142 may be employed to implement automatic pushing, automatic pulling, sending, and automatic filing operations as desired.

In certain implementations, the file-description association module 132 employs artificial intelligence or other mechanisms to observe and learn user behaviors to facilitate making automatic adjustments to the dialog boxes of FIGS. 2-4. In certain applications, the software running on the file-description association module 132 may learn sufficient information about a user's behavior to obviate the need for many or all of the questionnaires and dialog boxes of FIGS. 2-4. This further helps to automate various information-management tasks, such as filing, searching, and sending tasks. In general, the system 130 is readily adjustable and customizable to facilitate automating particular tasks, such as repeated tasks that are particular to a given organization or operating environment.

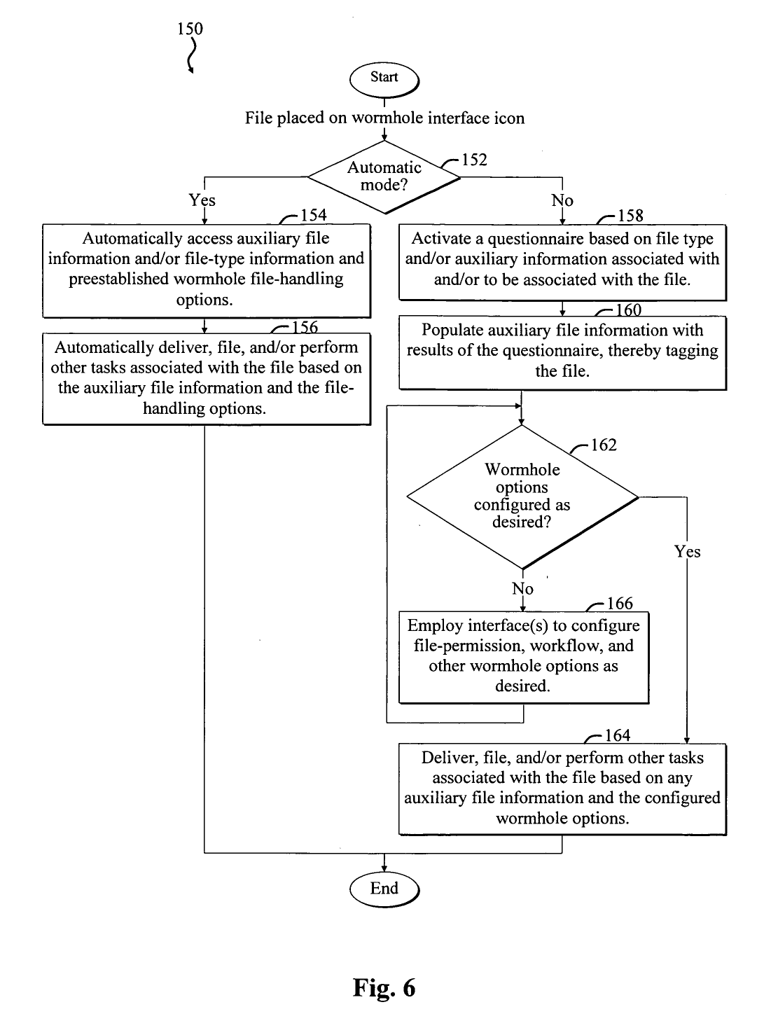

FIG. 6 is a flow diagram of a first exemplary method 150 adapted for use with the wormhole information-management interface 10 and accompanying information-management system 130 of FIG. 5. With reference to FIGS. 1-6, the method 150 begins when a file, such as the second file 18 of FIG. 2, is placed on the wormhole interface 10, which thereby activates an automatic-mode-checking step 152.

The automatic-mode-checking step 152 involves determining whether the wormhole interface 10 and accompanying system 130 of FIG. 5 are in an automatic mode as selected by a user, such as via the options dialog boxes 76, 78 of FIG. 4. In the present operative scenario, if the wormhole interface 10 and accompanying system 130 are in automatic mode, then an auxiliary-information access step 154 is performed next.

In the auxiliary-information access step 154, the file-description association module 132 of FIG. 5 automatically accesses auxiliary file information and/or file-type information, including preestablished wormhole file-handling options. Such auxiliary file information may already be appended to the file 18 or may otherwise be maintained in the auxiliary file-file information database 140 or may be automatically generated via the file-description association module 132 based on user observations and/or predetermined options.

In a subsequent performance step 156, the wormhole information-management system 130 of automatically delivers, files, and/or performs other tasks, such as workflows, based on the auxiliary file information, which includes predetermined file-handling options. Subsequently, the method 150 completes.

If the wormhole interface 10 and accompanying system 130 of FIG. 5 are not in automatic mode as determined via the auxiliary-information access step 152, then a questionnaire step 158 is performed next. In the questionnaire step 158, the file-description-association module 132 of FIG. 5 activates a questionnaire, such as the questionnaire 20 of FIG. 2, based on file type and/or other auxiliary information associated with and/or to be associated with the file 18. Additional auxiliary information pertaining to the file 18 is collected from the results of the questionnaire in a subsequent tagging step 160.

After the file 18 is tagged or otherwise associated with auxiliary information pertaining to the results of a questionnaire, an options-checking step 162 is performed. The options-checking step 162 includes determining if wormhole options are configured as desired. If options are configured as desired, then an implementing step 164 is performed, wherein the file 18 is delivered, filed, or subjected to a workflow in accordance with the auxiliary file information and the configured wormhole options.

If the wormhole options are not configured as desired as determined by the options-checking step 162, then an additional information-gathering step 166 is performed.

In the information-gathering step 166, the file-description association module 132 of FIG. 5 facilitates activating various additional dialog boxes, such as the dialog box 50 of FIG. 3 as needed to configured file permissions, workflow, and wormhole options as desired. The options-checking step 162 and the information-gathering step 166 repeat until the wormhole options are configured as desired, after which the implementing step 164 is performed, and the method 150 completes.

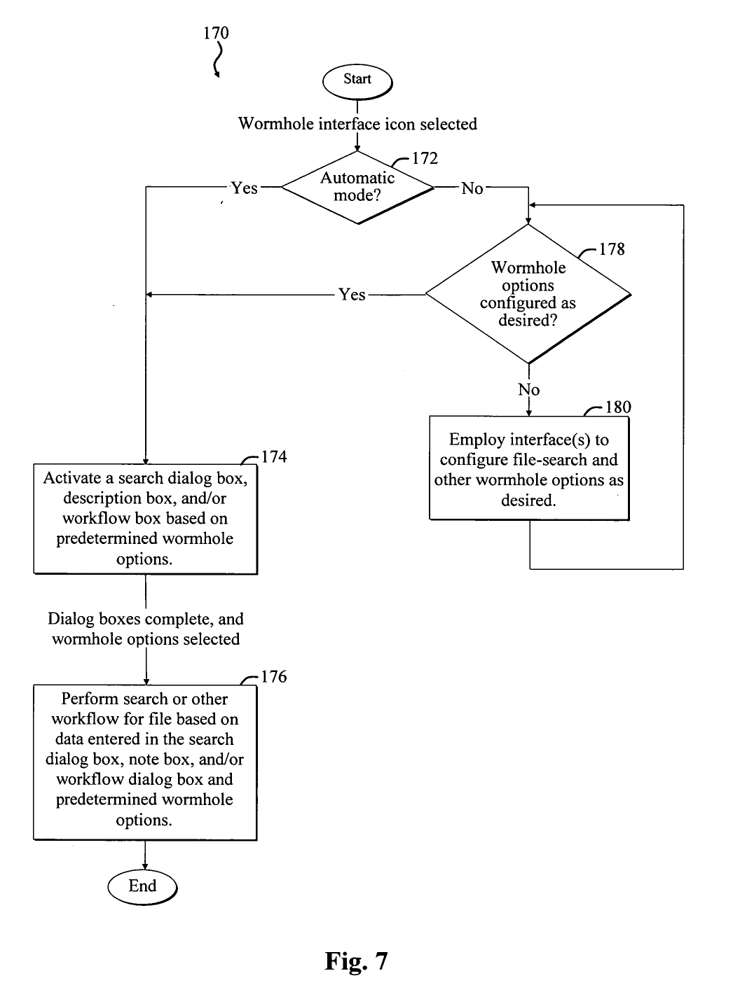

FIG. 7 is a flow diagram of a second exemplary method 170 adapted for use with the wormhole information-management interface 10 and accompanying information-management system 130 of FIG. 5.

With reference to FIGS. 4 and 5, the method 170 begins when a user selects the wormhole interface icon 10. In the present illustrative operative scenario, if the wormhole information-management interface 10 and accompanying system 130 are in automatic mode, as determined via an initial automatic-mode-checking step 172, then a box-activation step 174 is performed.

The box-activation step 174 includes activating a search dialog box, description dialog box, and/or workflow dialog box based on automatically determined or otherwise preestablished wormhole options.

A subsequent performance step 176 involves performing searches or other workflow tasks for a given file or files based on data entered in search dialog boxes, note dialog boxes, and/or workflow dialog boxes, in addition to other selected or automatically predetermined wormhole options. The method 170 completes after the performance step 176.

If the wormhole information-management interface 10 and accompanying information-management system 130 are not in automatic mode as determined via the automatic-mode-checking step 172, then an options-checking step 178 and an accompanying options-entering step 180 are performed until wormhole options are configured as desired. When wormhole options are configured as desired, the box-activation step 174 is performed.

Although the embodiments of the present invention have been discussed with respect to file-handling operations based on specific types of auxiliary file information, other types of auxiliary file information may be used without departing from the scope of the present invention. For example, auxiliary information indicating where a file was previously sent, what font appears in the file, whether the document has embedded objects, and so on, may be used to facilitate filing, sending, or performing other information-management tasks. Note that certain file-types, such as mp3, have meta-data in them, such as song author, album, and so on, that may be employed by various embodiments of the present invention to facilitate file-handling operations. The meta-data is considered to be a type of auxiliary file information.

Although the invention is discussed primarily with respect to content maintained on a personal computer, such as a client system, other types of computers, such as network servers may be employed to implement various routines and/or modules required to implement embodiments of FIGS. 1-7. Embodiments of the present invention may be implemented and/or maintained via any suitable file storage medium, network topology, transmission protocols, sender-receiver devices and relationships, and so on.

In general, any network or communication arrangement can be suitable for use with embodiments of the invention. Also, any communication protocols or other features or characteristics of data transfer may be employed.

While embodiments disclosed herein are discussed with reference to systems and methods for facilitating information-handling operations, such as file workflow operations based on auxiliary file information, embodiments of the present invention are not limited thereto. For example, any type of file data, either contained in the file or contained in an auxiliary log may be employed in file searches without departing from the scope of the present invention.

Although processes of the present invention and the hardware and/or software executing the processes may be characterized by language common to a discussion of the Internet (e.g., “client,” “server,” “peer”), it should be apparent that operations of the present invention can execute on any type of suitable hardware in any communication relationship to another device on any type of link or network.

Although a process of the present invention may be presented as a single entity, such as software executing on a single machine, such software can readily be executed on multiple machines. That is, there may be multiple instances of a given software program, a single program may be executing on two or more processors in a distributed processing environment, parts of a single program may be executing on different physical machines, etc. Furthermore, two different programs, such as a client and server program, can be executing in a single machine, or in different machines. A single program can be operating as a client for one information transaction and as a server for a different information transaction.

Any type of processing device can be used as a computer system for implementing embodiments of the present invention. For example, portable computing devices, such as a personal digital assistant (PDA), cell phone, laptop computer, or other devices can be employed. In general, the devices and manner of specific processing (including location and timing) are not critical to practicing important features of the present invention.

Although the invention has been discussed with respect to specific embodiments thereof, these embodiments are merely illustrative, and not restrictive, of the invention. Embodiments of the present invention can operate between any two processes or entities including users, devices, functional systems, or combinations of hardware and software. Peer-to-peer networks and any other networks or systems where the roles of client and server are switched, change dynamically, or are not even present are within the scope of the invention.

Any suitable programming language can be used to implement the routines or other instructions employed by various network entities. Exemplary programming languages include C, C++, Java, assembly language, etc. Different programming techniques can be employed such as procedural or object oriented. The routines can execute on a single processing device or multiple processors. Although the steps, operations or computations may be presented in a specific order, this order may be changed in different embodiments. In some embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport a program for use by or in connection with an instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented in whole or in part by using a programmed general purpose digital computer; by using application specific integrated circuits, programmable logic devices, field programmable gate arrays, optical, chemical, biological, quantum or nanoengineered systems or mechanisms; and so on. In general, the functions of the present invention can be achieved by any means as is known in the art. Distributed or networked systems, components, and/or circuits can be used. Communication, or transfer of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”,“an” and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments, and equivalents falling within the scope of the appended claims.

What is claimed is:

1. A method for selectively managing data comprising:
determining data-handling instructions;
automatically performing one or more tasks associated with a piece of data and in accordance with the data-handling instructions in response to activation of the data-handling instructions via the piece of data or a representation thereof.

2. The method of claim 1 wherein the data-handling instructions are activated in response to
placing a graphical representation of the piece of data on an icon.

3. The method of claim 2 wherein the icon is associated with
a data-handling system that is adapted to facilitate implementing the data-handling instructions in response to placing the graphical representation of the piece of data on the icon.

4. The method of claim 2 wherein the data-handling instructions optionally include
workflow instructions.

5. The method of claim 4 wherein the workflow instructions include
delivering the piece of data to a predetermined computer.

6. The method of claim 4 wherein the data-handling instructions include
storing the piece of data in a particular location in a directory structure, the particular location being based on a data description incorporated in or associated with the data-handling instructions.

7. The method of claim 4 wherein the data-handling instructions include
retrieving the piece of data.

8. A method for facilitating managing information comprising:
employing an interface to establish desired options for handling a piece of information;
specifying one or more tasks for the piece of information;
associating the piece of information with a tag containing or referencing the desired handling options and/or the one or more tasks; and
automatically implementing the one or more tasks upon selective activation of the interface.

9. The method of claim 8 wherein selective activation occurs by
selecting the interface via the piece of information or via information related to the piece of information.

10. A method for facilitating managing information comprising:
employing an interface to establish desired options for handling a piece of information;
indicating one or more tasks for the piece of information; and
automatically implementing the one or more tasks upon selective activation of the interface, the selective activation occurring via the piece of information or via information related to the piece of information.

11. The method of claim 10 wherein the interface is represented via
a first graphical representation, the first graphical representation being selectively activated by placing a second graphical representation the piece of data on the first graphical representation.

12. The method of claim 10 wherein the piece of information includes
a file.

13. The method of claim 12 wherein the desired options are preestablished options.

14. The method of claim 13 wherein the desired options are configurable by a user of
an information-managing system that is adapted for use with the method.

15. The method of claim 14 wherein the information related to the piece of information includes
a file icon.

16. The method of claim 15 wherein the interface includes
a managing-system icon.

17. The method of claim 16 wherein selective activation of the interface occurs in response to
placing the file icon on the managing-system icon.

18. The method of claim 10 wherein the piece of information includes
search criteria.

19. The method of claim 18 wherein the one more tasks includes
implementing a search for the piece of information based on the search criteria.

20. The method of claim 19 wherein the one or more tasks includes
delivering the piece of information to a user of the method via the interface.

21. The method of claim 10 wherein automatically implementing includes
placing an icon associated with the piece of information on an interface icon associated with the interface.

22. A file-managing method adapted for use with a file-managing system comprising:
providing a user with options pertaining to file-handling operations and providing selected options in response thereto;
generating a directory structure based on the selected options; and
automatically filing a file in the directory structure based on the file-handling options and in response to activation of the file-managing system via the file.

23. A system for managing information comprising:
one or more interface icons represented via an interface of a first computer;
a file icon and
first means for selectively activating functionality associated with the one or more interface icons, the functionality including:
second means for triggering a workflow for handling a file associated with the file icon by moving the file over a predetermined region of the interface.

24. The system of claim 23 wherein the first means further includes
third means for associating the file with the workflow.

25. The system of claim 24 wherein the third means further includes
means for tagging the file with information pertaining to the workflow and/or one or more user options or preferences.

26. A system for facilitating managing information comprising:
an interface icon;
a file-description-association module in communication with the interface icon, the file-description-association module activated in response to a first type of activation of the interface icon;
an automatic filing and retrieval module in communication with the file-description association module; and
a directory structure in communication with the automatic filing and retrieval module.

27. The system of claim 26 further including
a search engine, the search engine being activated in response a second type of activation of the interface icon.

28. The system of claim 27 further including an auxiliary-file information database.

29. The system of claim 28 wherein the auxiliary-file information database communicates with the automatic filing and retrieval module.

30. The system of claim 26 further including
a workflow module in communication with the directory structure.

31. The system of claim 30 wherein the directory structure is automatically generated via the automatic filing and retrieval module.
